(19) United States
(12) Patent Application Publication
(10) Pub. No.: US 2013/0112862 A1
(43) Pub. Date: May 9, 2013

(54) SYSTEM AND METHOD FOR DILUTION OF A SAMPLE FOR INTRODUCTION TO A QUANTITATIVE ANALYSIS APPARATUS

(71) Applicant: Marcus Kock Wha LAU, Vancouver (CA)

(72) Inventor: Marcus Kock Wha LAU, Vancouver (CA)

(73) Assignee: ACME ANALYTICAL LABORATORIES LTD., Vancouver (CA)

(21) Appl. No.: 13/292,981

(22) Filed: Nov. 9, 2011

(51) Int. Cl. H01J 49/26; G01N 1/14

(52) U.S. Cl. 250/282; 73/864.12; 250/288

(57) ABSTRACT

A system for insitu dilution of a sample followed by volume reduction prior to introduction to a quantitative analysis apparatus. The system includes a first inlet for introducing the sample to the system, a second inlet for flow of a diluent introduced into the system separate of the sample, a mixing chamber in fluid connection with the first and second inlets for receiving and mixing the sample and the diluent in a common flow path to provide a solution, and a separator to accomplish volume reduction and for separating a portion of the solution for introduction into the analysis apparatus from a remainder of the solution.

### TECHNICAL FIELD

The present invention relates to sample dilution for solution sample introduction in quantitative analysis such as analysis using an inductively coupled plasma mass spectrometer.

### BACKGROUND DISCUSSION

Inductively coupled plasma mass spectrometer (ICP-MS) instruments have a finite range for effective analysis of solutions. Typically, ICP-MS instruments are effective for analysis of concentrations below about 1 part per billion (ppb) up to hundreds of parts per million (ppm). Above such concentrations, suitable isotopes saturate the detector in the ICP-MS instrument. Additionally, analyzing solutions containing high total dissolved solids causes suppression of the signal due to the enhancement of a characteristic known as matrix effect. Dilution of samples allows a lower concentration of solution to be introduced to the instrument for analysis and the total dissolved solids is decreased to reduce the matrix effect. Dilution also reduces acidity of the sample to be analyzed, thereby increasing the lifetime of the instrument.

A portion of test material may be digested with acid, diluted and aspirated into an ICP-MS instrument for the determination of elemental concentrations of the original sample. It will be appreciated that a very wide range of elemental concentrations can be encountered in such samples, however. After acid digestion, the acid solutions are diluted down to a suitable solution concentration for analysis in the ICP-MS instrument. If the sample is not sufficiently diluted, the instrument is saturated by high element concentration. If the sample is diluted too much, the element concentration may fall below detection limits of the instrument.

Sample dilution is commonly performed by manual addition of water to each sample, or using an automatic diluter to add water to each test tube or beaker in a rack. Such dilution is carried out by separation of a small sample, such as 1 ml, of the acidic solution into a text tube or beaker, followed by the addition of a large volume of water, for example, in the range of 30 to 150 mls. Such dilution processes are slow and commonly result in errors. Slow speed is particularly problematic in a commercial laboratory where, for example, upwards of 100,000 samples may be processed monthly. Compounding the problems, samples can not be diluted long in advance due to the possibility of precipitation of solids as a result of the decrease in acidity.

While other types of automated systems are available, such automated systems suffer from many problems including, for example, poor mixing of the sample and diluent, contamination between samples, consumption of glassware such as additional test tubes or beakers for mixing, slow speed, loss of sample due to precipitation, and inability to handle suitable (higher) dilution rates. Dilution rate is critical as a wide range of sample matrix is routinely encountered. Samples with high metals content require higher dilution rates to prevent the ICP-MS instrument detector from becoming saturated.

After dilution, only a small portion of the diluted sample is aspirated into the instrument as difficulties are experienced in attempting to run large volumes of solution through the instrument. These difficulties result from rapid build up of residue in cone-based ICP-MS instruments, causing instrument drift.

### SUMMARY

According to one aspect, there is provided a system for dilution of a sample prior to introduction to a quantitative analysis apparatus. The system includes a first inlet for introducing the sample to the system, a second inlet for flow of a diluent introduced into the system separate of the sample, a mixing chamber connected to the first and second inlets for receiving and mixing the sample and the diluent in a common flow path to provide a solution, and a separator for separating a portion of the solution for introduction into the apparatus from a remainder of the solution.

According to another aspect, there is provided a method of diluting a sample for quantitative analysis. The method includes introducing a sample for dilution into a system, controlling flow of a diluent to separately introduce the diluent into the system, mixing the sample and the diluent in a common flow path to provide a solution, reducing the volume of the solution by separating a portion of the solution for quantitative analysis from a remainder of the solution, and introducing the portion of the solution to an analyzer for quantitative analysis.

Other aspects and features will become apparent to those ordinarily skilled in the art upon review of the following description of specific in conjunction with the accompanying figures.

### BRIEF DESCRIPTION OF THE DRAWINGS

Embodiments of the present application will now be described, by way of example only, with reference to the attached Figures, wherein:

FIG. 1 is a schematic view of a system for dilution of a sample for introduction to a quantitative analysis apparatus, according to one embodiment of the present invention; and

FIG. 2 is a schematic view of a portion of the system of FIG. 1, drawn to a larger scale.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limited to the scope of the embodiments and examples described herein.

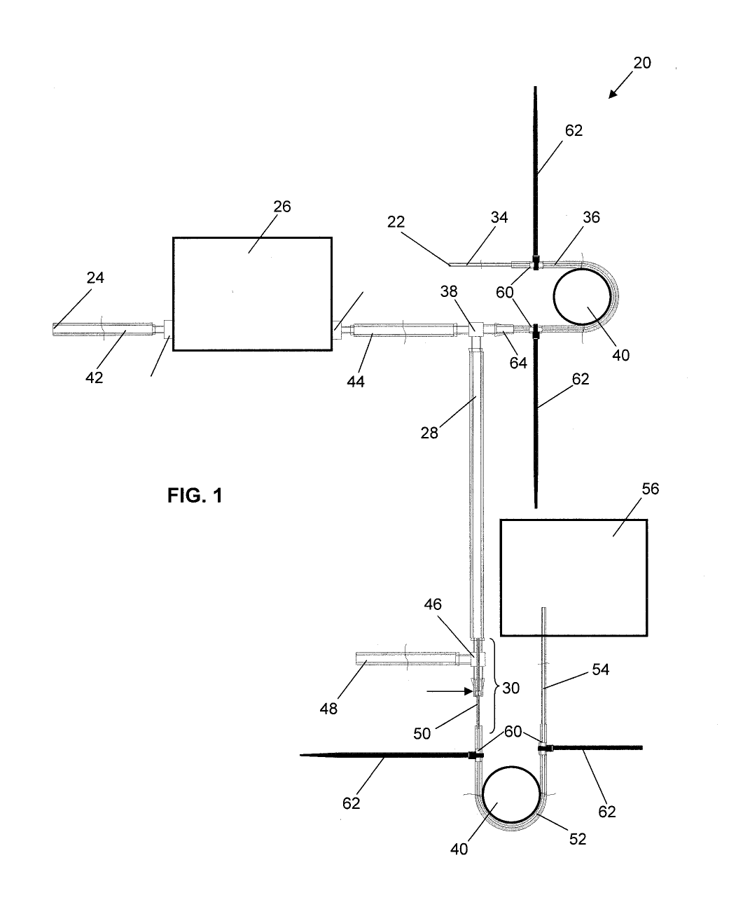

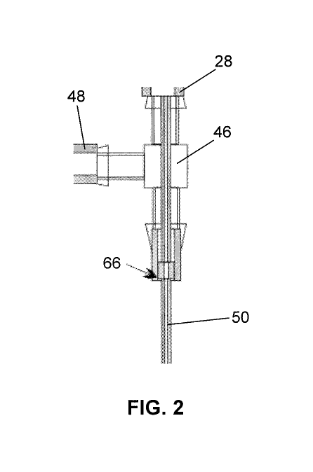

Referring to FIGS. 1 and 2, a system for dilution of a sample prior to introduction to a quantitative analysis apparatus is indicated generally by the numeral 20. The system 20 includes a first inlet 22 for introducing the sample to the system 20, a second inlet 24 and a flow controller 26 cooperating with the second inlet 24 for controlling flow of a diluent introduced into the system 20 separate of the sample. A mixing chamber 28 is fluidly connected to the first and second inlets 22, 24 for receiving and mixing the sample and the diluent in a common flow path to provide a solution, and a separator 30 for separating a portion of the solution for introduction into the apparatus from a remainder of the solution.

Continued reference is made to FIGS. 1 and 2 to describe a system for dilution of a sample and subsequent volume reduction in accordance with one embodiment in greater detail. A controlled volume of sample (acid-digested solid) received at the inlet is mixed with a controlled volume of diluent (i.e. demineralized water) received through the second inlet 24, in the mixing chamber to provide a mixed solution. A controlled portion of the solution is separated for testing in an ICP-MS instrument and the remainder is drained off.

Referring to the introduction of the sample to the system 20, the sample is introduced through the first inlet 22 formed by an end of a microbore sample tube 34. The microbore sample tube 34 is connected at an opposing end to a larger-bore sample tubing 36 that is, in turn, connected to the mixing chamber 28 via a mixing T-connector 38. The flexible tubing 36 extends around a pump head of a peristaltic pump represented by the numeral 40, for controlling the flow of the sample into the first inlet 22, through the microbore sample tube 34 and the flexible tubing 36. Thus, the sample is induced into the first inlet 22 and forced through the flexible tubing 36, through the mixing T-connector 38, into the mixing chamber 28. The first inlet 22 is thereby in fluid connection with the mixing chamber 28.

The diluent (i.e. demineralized water) enters the system through the second inlet 24 formed by one end of a diluent tube 42 of suitable material. The diluent tube 42 is connected at the one end to a diluent source such as a demineralized water source. The diluent tube 42 is also fluidly connected, at the other end, to the mixing T-connector 38 via the intermediary flow controller 26 and a diluent connecting tube 44. Thus, the diluent tube 42 is connected at an end, opposite the inlet 24, to an inlet of the flow controller 26 using a suitable connector. An outlet of the flow controller 26 is, in turn, connected to one end of the diluent connecting tube 44 by a suitable connector. The opposite end of the diluent connecting tube 44 is connected to the mixing T-connector 38. The diluent is therefore pumped from the second inlet 24, through the diluent tube 42, the flow controller 26 and the diluent connecting tube 44 and into the mixing chamber 28. The second inlet 24 is thereby in fluid connection with the mixing chamber 28.

The sample induced into the system at the first inlet 22 and the diluent pumped into the system at the second inlet 24 are mixed together in the mixing chamber 28. The mixing chamber 28 is of sufficient diameter and length to permit full mixing of the sample and diluent to form a generally homogeneous solution.

The mixing chamber 28 in the present embodiment is a tube and is connected at an opposing end to a solution T-connector 46 for joining the mixing chamber 28 to a drain tube 48 and a smaller-diameter solution tube 50. The solution tube 50 has a diameter that is smaller than both the drain tube 48 and the mixing chamber 28. In the present embodiment, the drain tube 48 and the mixing chamber 28 have approximately equal internal diameters while the solution tube 50 has a diameter that is smaller than that of the drain tube 48 and the mixing chamber 28. The relatively smaller diameter solution tube 50 is inserted into the solution T-connector 46, such that the solution tube 50 extends into the solution T-connector 46 for passage of a portion of the solution from the mixing chamber 28 into the solution tube 50. The solution is inhibited from passing through the solution T-connector 46 around the outside of the solution tube 50, between the solution T-connector 46 and the solution tube 50.

At an opposite end, the solution tube 50 is connected to one end of a flexible solution pumping tube 52. The opposing end of the solution pumping tube 52 is connected to an analyzer tube 54 for introduction of the portion of the solution into an ICP-MS instrument 56. The pumping tube 52 extends around a pump head of a peristaltic pump for controlling the flow of solution into the solution tube 50. In the present embodiment, the pumping tube 52 extends around a separate channel of the same peristaltic pump 40 as the flexible sample tubing 36. The peristaltic pump 40 is therefore a multi-channel pump for displacing fluid through more than one tube. Thus, the portion of the solution is induced into the solution tube 50 and forced through the flexible solution pumping tube 52, through the analyzer tube 54 and into the ICP-MS instrument 56. The solution tube 50 is thereby in fluid connection with the ICP-MS instrument 56.

In use, the sample is introduced into the system 20 via the first inlet, pumped through the flexible sample tubing 36 and into the mixing chamber 28. The diluent is introduced through the second inlet 24 and the flow of the diluent is controlled by the flow controller 26. The sample and the diluent are mixed together in the common flow path of the mixing chamber 28 to create a solution. A portion of the solution is separated as it is induced into the solution tube 50 for pumping into the ICP-MS instrument 56. The remainder of the solution is drained off.

The following specific example is provided for the purpose of illustration of assembly of a system in accordance with the embodiment as described above. This example is intended to be illustrative only and is not intended to limit the scope of the present invention.

To assemble the exemplary system 20, the flexible sample tubing 36 is prepared by cutting a length of tubing of, for example, about 9″ (228 mm) of Tygon™ tubing, having an internal diameter of 0.0299″ (0.76 mm) and outer diameter of 0.098″ (2.49 mm). Short sections 60 of a larger diameter tubing, for example, 0.375″ (9.53 mm) in length having an internal diameter of 0.0912″ (2.32 mm) and an outer diameter of 0.1582″ (4.02 mm) are cut lengthwise to open the short sections 60 and the short sections 60 are wrapped around the length of tubing, proximal respective ones of opposing ends thereof. The short sections 60 are secured around the tubing, for example, using zip ties 62, as shown in FIG. 1. The zip ties 62 are positioned on the length of tubing for latching on to slots of the peristaltic pump 40 and are tightened to secure the short sections 60 in place without restricting flow through the tubing.

The prepared flexible sample tubing 36 is then wrapped around rollers of the peristaltic pump 40. An exemplary suitable peristaltic pump is a Gilson Minipuls 3, manufactured by Gilson Inc., Middleton, Wis.. Each zip tie 62 wrapped around the respective short section 60 acts as a stop. These stops are each positioned in respective slots of a channel of the peristaltic pump 40. The tubing is then clamped and the tension adjusted with a screw at the back of the clamp on the peristaltic pump 40 such that the sample flows smoothly. Smooth flow can be tested, for example, by submerging one end of the tubing in water, turning the pump on to an appropriate speed (such as pump speed 24) and adjusting the screw until the solution flows smoothly.

The solution pumping tube 52 is prepared in a similar manner by cutting a length of tubing of, for example, 9″ of Tygon™ tubing, having an internal diameter of (0.76 mm) and outer diameter of 0.098″ (2.49 mm). Again, short sections 60 of a larger diameter tubing, for example, (9.53 mm) in length having an internal diameter of 0.0912″ (2.32 mm) and an outer diameter of 0.1582″ (4.02 mm) are cut lengthwise and are wrapped around the length of tubing, proximal opposing ends thereof. The short sections 60 are secured around the tubing, for example, using zip ties 62 that are positioned on the length of tubing for latching on to slots of the peristaltic pump 40 and are tightened to secure the short sections 60 in place without restricting flow through the tubing.

The prepared solution pumping tube 52 is then wrapped around rollers of a second channel of the peristaltic pump 40. Each zip tie 62 wrapped around the respective short section 60 acts as a stop. These stops are each positioned in respective slots of the second channel of the peristaltic pump 40. The tubing is then clamped and the tension adjusted with a screw at the back of the clamp on the peristaltic pump 40 such that the solution flows smoothly.

The upstream, or sample end of the flexible sample tubing 36 is stretched using a suitable device and the microbore tube 34 of, for example, 0.02″ (0.51 mm) internal diameter and 0.06″ (1.52 mm) outer diameter, is inserted about 1/16″ (1.59 mm) into the stretched end of the flexible sample tubing 36.

The other end of the flexible sample tubing 36 is connected to the mixing T-connector 38, which can be a 0.125″ (3.175 mm) polypropylene T-connector. An adapter 64 such as a short length of, for example, 0.375″ (9.53 mm) of Tygon™ tubing having an internal diameter of 0.0912″ (2.32 mm) and an outer diameter of 0.1582″ (4.02 mm), is used to connect the flexible sample tubing 36 to the mixing T-connector 38. Thus, with the mixing T-connector 38 inserted into the adapter 64, the flexible sample tubing 36 is inserted into the adapter 64 until the flexible sample tubing 36 contacts the mixing T-connector 38.

One example of a suitable flow controller 26 is an LC-100CCM-D Liquid flow controller manufacture by Alicat Scientific Inc, Tucson, Ariz. Connecting fittings such as polypropylene ¼″ to ⅛″ (6.35 mm to 3.175 mm) fittings are connected at each of the two ends of the flow controller 26. The inlet side of the flow controller 26 is connected to a water source of suitable pressure and flow rate, such as 5 psi pressure or greater and flow rate of 100 ml per minute or greater, by the diluent tube 42. A suitable diluent tube 42 can be a length of Tygon™ tubing having an internal diameter of 0.0912″ (2.32 mm) and an outer diameter of 0.1582″ (4.02 mm)″. The diluent connecting tube 44 joins the outlet side of the flow controller 26 to the mixing T-connector 38. The diluent connecting tube 44 can also be a length of Tygon™ tubing having an internal diameter of 0.0912″ (2.32 mm) and an outer diameter of 0.1582″ (4.02 mm).

The mixing chamber 28 can be, for example, a 3.5″ (89 mm) length of Tygon™ tubing having an internal diameter of 0.0912″ (2.32 mm) and an outer diameter of 0.1582″ (4.02 mm) and is connected at one end to the mixing T-connector 38 and at the opposing end to the solution T-connector 46. Like the mixing T-connector 38, the solution T-connector 46 can be a 0.125″ (3.175 mm) polypropylene T-connector.

The solution tube 50 is connected at the opposing end of the solution T-connector, in line with the mixing chamber 28. To connect the solution tube 50, a solution adapter 66 is used. A suitable solution adapter can include a first portion of a short length of, for example, 0.375″ (9.53 mm) of Tygon™ tubing having an internal diameter of 0.0912″ (2.32 mm) and an outer diameter of 0.1582″ (4.02 mm) that is inserted over the end of the T-connector, opposite the mixing chamber 28. The solution adapter 66 also includes a second portion of short length of, for example, 0.125″ (3.18 mm) of Tygon™ tubing having an internal diameter of 0.0299″ (0.76 mm) and an outer diameter of 0.098″ (2.49 mm) that is stretched to fit over the solution tube 50. The solution tube 50 can be, for example, Tygon™ tubing having an internal diameter of 0.02″ (0.51 mm) and an outer diameter of 0.06″ (1.52 mm) and is inserted into the second portion of the solution adapter 66 such that the solution tube 50 extends past the second portion about ½″ (12.7 mm). The second portion is then inserted into the first portion of the adapter 66 such that the solution tube 50 is inserted into the solution T-connector 46 and is in contact with the end of the solution T-connector 46, adjacent the mixing chamber 28.

The drain tube 48 is connected to the remaining end of the solution T-connector 46. Any suitable drain tube 48 can be used such as a length of Tygon™ tubing having an internal diameter of 0.0912″ (2.32 mm) and an outer diameter of 0.1582″ (4.02 mm).

One end of the solution pumping tube 52 is connected to the solution tube 50 and the other end of the solution pumping tube 52 is connected to the analyzer tube 54 for introduction of the portion of solution into the ICP-MS instrument 56. The analyzer tube 54 can be, for example, Tygon™ tubing having an internal diameter of 0.02″ (0.51 mm) and an outer diameter of 0.06″ (1.52 mm).

The flexible sample tubing 36 and the solution pumping tube 52 are shown in different locations in FIG. 1 for the purpose of clarity of the illustrated features. It will be appreciated that, as described above, the flexible sample tubing 36 and the solution pumping tube 52 can be employed in different channels of the same pump.

In the preceding description, for purposes of explanation, numerous details are set forth in order to provide a thorough understanding of the embodiments of the present application. However, it will be apparent to one skilled in the art that certain specific details are not required. In other instances, features, including functional features, are shown in block diagram form in order not to obscure the description. Further, certain Figures and features are simplified for ease of understanding.

The system for insitu dilution of a sample followed by volume reduction for introduction to a quantitative analysis apparatus permits accurate auto-dilution with high dilution ratios, for example, up to 200 times of target sample solutions. The mixing chamber of large bore tubing is of sufficient diameter and length to provide for generally homogeneous, mixed solutions for analysis. Further, an automatic drain system is integral with the system for draining off excess solution to thereby provide a desirable volume of solution to the analysis instrument (ICP-MS). Further, contamination is very low as compared to prior art methods while precipitation of the sample is inhibited as the auto-dilution of the target sample occurs in-line, immediately prior to aspiration of the sample in the ICP-MS. The auto-dilution system, together with integral volume reduction through drainage of excess solution permits operation to provide a wide dynamic range of element concentrations and low detection limits on a much larger variety of sample type and sample matrix.

While the embodiments described herein are directed to particular implementations of the system and method for insitu dilution of a sample and volume reduction prior to introduction to a quantitative analysis apparatus, it will be understood that modifications and variations to these embodiments are within the scope and sphere of the present application. It will also be appreciated that the above-described embodiment is intended to be an example only. Alterations, modifications and variations can be effected to the particular embodiments by those of skill in the art without departing from the scope of the present application, which is defined solely by the claims appended hereto.

What is claimed is:

1. A system for dilution of a sample for introduction to a quantitative analysis apparatus, the system comprising:
a first inlet for introducing the sample to the system;
a second inlet for flow of a diluent into the system separate of the sample;
a mixing chamber in fluid connection with the first and second inlets for receiving and mixing the sample and the diluent in a common flow path to provide a solution; and
a separator for volume reduction by separating a portion of the solution for introduction into the apparatus from a remainder of the solution.

2. The system according to claim 1, wherein the first inlet comprises a first inlet tube.

3. The system according to claim 2, comprising a pump in cooperation with the first inlet tube for pumping the sample into the system.

4. The system according to claim 2, wherein the separator comprises a solution tube for receiving the portion of solution and a drain tube for draining the remainder of the solution.

5. The system according to claim 4, wherein the separator comprises a T-connector connecting the drain tube to the mixing chamber and the solution tube.

6. The system according to claim 4, comprising a pump in cooperation with the solution tube for pumping the solution into the apparatus.

7. The system according to claim 4, comprising a pump having at least two channels for cooperating with the first inlet tube and the solution tube, respectively for pumping the sample into the system and for pumping the portion of the solution into the apparatus.

8. The system according to claim 5, wherein the pump is a peristaltic pump.

9. The system according to claim 1, wherein the mixing chamber is connected to the first and second inlets by a T-connector.

10. The system according to claim 1, comprising the quantitative analysis apparatus.

11. The system according to claim 10, wherein the apparatus is an inductively coupled plasma mass spectrometer.

12. The system according to claim 1, comprising a flow controller in cooperation with the second inlet for controlling the flow of the diluent into the mixing chamber.

13. The system according to claim 1, wherein the mixing chamber comprises a tube.

14. A method of diluting a sample for quantitative analysis, comprising:
introducing a sample for dilution into a system;
controlling flow of a diluent to separately introduce the diluent into the system;
mixing the sample and the diluent in a common flow path to provide a solution;
separating a portion of the solution to reduce the volume for quantitative analysis from a remainder of the solution; and
introducing the portion of the solution to an analyzer for quantitative analysis.

15. The method according to claim 14, wherein introducing the sample comprises pumping the sample through a first inlet tube.

16. The method according to claim 14, wherein separating comprises draining off the remainder of the solution.

17. The method according to claim 16, wherein introducing the portion of the solution comprises pumping the portion of the solution from the common flow path, through a solution tube.

18. The method according to claim 17, wherein introducing the portion of the solution comprises introducing the portion of the solution to an inductively coupled plasma mass spectrometer.
